(19) United States
(12) Patent Application Publication
(10) Pub. No.: US 2024/0426010 A1
(43) Pub. Date: Dec. 26, 2024

(54) METHOD AND CONTROL MODULE FOR OPERATING ELECTROLYSIS PLANT

(71) Applicant: Hitachi Energy Ltd, Zürich (CH)

(72) Inventors: JiaKun FANG, Wuhan, Hubei (CN); KeWei HU, Wuhan, Hubei (CN); ZhiYao ZHONG, Wuhan, Hubei (CN); DanJi HUANG, Wuhan, Hubei (CN); YuHeng YING, Wuhan, Hubei (CN); Chuang WANG, Wuhan, Hubei (CN); XiaoBo YANG, Beijing (CN)

(21) Appl. No.: 18/728,398

(22) PCT Filed: Jan. 28, 2022
(86) PCT No.: PCT/EP2022/052038

§ 371 Date: Jul. 11, 2024

(51) Int. Cl. C25B 15/027; C25B 1/04; C25B 15/021; C25B 15/08

(52) U.S. Cl. CPC C25B 15/027; C25B 1/04; C25B 15/021; C25B 15/08

(57) ABSTRACT

The present disclosure relates to a method and control module for operating an electrolysis plant (EP), an electrolysis plant, and a method for dispatching at least one electrolysis plant in a power system. The electrolysis plant comprises an electrolysis stack assembled from a plurality of electrolysis cells. The method for operating the electrolysis plant comprises, by a control module, adapting a multiphysics model to a plurality of operation parameters of the electrolysis plant. The multiphysics model comprises a one-dimensional liquid-gas diphasic flow model and an electrochemical model coupled with the diphasic flow model. The plurality of operation parameters comprises preset parameter(s) and parameter(s) to be calculated. A value of each parameter to be calculated is calculated according to a preset value of the preset parameter(s) by means of the multiphysics model. Control to the electrolysis plant is executed according to the calculated value of the parameter(s) to be calculated.

### TECHNICAL FIELD

The present disclosure relates to the technical field of electrolyzer control. More specifically, the present disclosure relates to a method for operating an electrolysis plant, a control module for operating an electrolysis plant, an electrolysis plant, and a method for dispatching at least one electrolysis plant in a power system.

### BACKGROUND

Hydrogen is regarded as one of the most promising secondary energy in the 21^{st} century. Meanwhile, the emerging concept of integrated energy systems is strengthening the association of power and gas systems. As an energy conversion sector, power-to-hydrogen (“PtH”), especially water electrolysis, has been recognized as an essential element in future integrated energy systems for grid balancing and coupling of power and gas systems.

Low-temperature water electrolyzer is characterized in a liquid-gas diphasic flow. For a zero-gap cell in which no flow channel exists between two electrodes, bubbles adhered to the electrodes tend to reduce effective area of an electrochemical reaction. For a gap cell in which water flows between two electrodes, bubbles not only reduce effective area of the electrodes but also decrease conductivity of water. To conclude, the bubble effect has pronounced impact on the electrochemical reaction, for which a compelling mathematical model of electrolyzer should be taken into account. Therefore, a diphasic flow model is prevalently adapted in low-temperature water electrolysis modeling.

There are at present three kinds of diphasic flow models in water electrolysis researches: the Euler-Euler model, the Euler-Lagrange model and the mixture model. These models are usually adapted in the research of a single electrolysis cell and are solved using a numerical method. However, the applied electrolyzers in practical are usually compactly assembled in stack, accompanied by auxiliary components like a pump and a heat exchanger. Therefore, the existing diphasic flow models are not suitable for a stack or plant level electrolyzer for several reasons:
The movements of liquid and gas are modeled by highly nonlinear partial differential equations. The existing models can only be solved by CFD (Computational Fluid Dynamics) methods, wherein the precise geometry of the electrolyzer should be established. As a result, they can only be applied to the modeling of a single electrolysis cell. Obviously, it is not suitable for a systematic simulation of electrolyzer with a power system.
The parameters of liquid and gas are strongly coupled, thereby worsening convergence of the diphasic flow models.
Although only the bubbles near the electrodes influence the electrolysis process, the existing models solve variables in the whole flow channel, thereby enlarging the computing scale.

### SUMMARY

In view of the above, the present disclosure aims at proposing a multiphysics model comprising a new diphasic model for operating a large-scale electrolysis plant, which is linear so as to ensure a simplified calculation.

To this end, a first aspect of the present disclosure provides a method for operating an electrolysis plant. The electrolysis plant comprises an electrolysis stack assembled from a plurality of electrolysis cells; and at least one electrolysis auxiliary component arranged upstream or downstream of the electrolysis stack. The method comprises following steps executed by a control module: a) adapting a multiphysics model to a plurality of operation parameters of the electrolysis plant, wherein the multiphysics model comprises a one-dimensional liquid-gas diphasic flow model and an electrochemical model coupled with the diphasic flow model, and the plurality of operation parameters comprises at least one preset parameter and at least one parameter to be calculated; b) calculating a value of the at least one parameter to be calculated according to a preset value of the at least one preset parameter by means of the multiphysics model; and c) executing control to the electrolysis plant according to the calculated value of the at least one parameter to be calculated.

Thus, the multiphysics model comprising a one-dimensional diphasic flow model allows an easy and fast control to the electrolysis plant (stack or plant level electrolyzer) through a simplified calculation.

According to a preferred embodiment of the present disclosure, the at least one electrolysis auxiliary component comprises at least one of a heater, a heat exchanger and a pump, wherein the heater or the heat exchanger is configured to control temperature of electrolyte circulated in the electrolysis plant according to a control signal provided to the heater or the heat exchanger, and the pump is configured to control flow rate of the electrolyte according to a control signal provided to the pump.

According to a preferred embodiment of the present disclosure, the step b) comprises calculating a value of the flow rate of the electrolyte according to preset values of current density and anodic and cathodic void fractions by means of the diphasic flow model established for a single electrolytic cell based on mass conservation, momentum conservation, assumptions of homogeneous flow and steady parallel flow and the Faraday's law, and the step c) comprises determining the control signal provided to the pump according to the calculated value of the flow rate, and executing control to the pump according to the control signal provided to the pump.

According to a preferred embodiment of the present disclosure, the flow rate of the electrolyte is represented by the following equation based on momentum conservation and assumptions of homogeneous flow and steady parallel flow in order to simplify the calculation:

$$v = {v}_{l} ( x ) = \frac{4 {v}_{in}}{{X}^{2}} x ( X - x )$$

wherein v represents the flow rate of gas, vₗ represents the flow rate of the electrolyte, vᵢₙ represents the flow rate of the electrolyte at a central position along a width direction of a flow channel of the electrolysis cell, x represents the width position in the flow channel, and X represents the total width of the flow channel.

According to a preferred embodiment of the present disclosure, the step b) comprises calculating values of the temperature of the electrolyte and supplied voltage provided to the electrolysis stack according to preset values of current density and anodic and cathodic void fractions by means of the electrochemical model established for a single electrolytic cell based on the Kirchhoff's voltage law and the Bulter-Volmer equation, and the step c) comprises determining the control signal provided to the heater or the heat exchanger according to the calculated value of the temperature, and executing control to the heater and the electrolysis stack respectively according to the control signal provided to the heater or the heat exchanger and the supplied voltage provided to the electrolysis stack.

According to a preferred embodiment of the present disclosure, after the step c), the method further comprises a following step: measuring a value of at least one operation parameters of the electrolysis plant and observing if the measured value varies abruptly over a time period, so as to identify if a failure happens in the electrolysis plant.

According to a preferred embodiment of the present disclosure, the at least one measured operation parameter comprises supplied voltage provided to the electrolysis stack and current flowing through the electrolytic stack.

A second aspect of the present disclosure provides a control module for operating an electrolysis plant. The electrolysis plant comprises an electrolysis stack assembled from a plurality of electrolysis cells; and at least one electrolysis auxiliary component arranged upstream or downstream of the electrolysis stack. The control module is configured to: adapt a multiphysics model to a plurality of operation parameters of the electrolysis plant, wherein the multiphysics model comprises a one-dimensional liquid-gas diphasic flow model and an electrochemical model coupled with the diphasic flow model, and the plurality of operation parameters comprises at least one preset parameter and at least one parameter to be calculated; calculate a value of the at least one parameter to be calculated according to a preset value of the at least one preset parameter by means of the multiphysics model; and execute control to the electrolysis plant according to the calculated value of the at least one parameter to be calculated.

A third aspect of the present disclosure provides an electrolysis plant comprising the control module according to the second aspect of the present disclosure.

A fourth aspect of the present disclosure provides a method for dispatching at least one electrolysis plant in a power system. The power system comprises at least one electric device electrically connected to the at least one electrolysis plant comprising an electrolysis stack assembled from a plurality of electrolysis cells. The method comprises following steps: adapting a multiphysics model to a plurality of operation parameters of the at least one electrolysis plant, wherein the multiphysics model comprises a one-dimensional liquid-gas diphasic flow model and an electrochemical model coupled with the diphasic flow model; running the multiphysics model together with a model of the power system based on at least one of the plurality of operation parameters associated with the power system; and determining state of operation of the at least one electrolysis plant based on a running result to optimize performance of the power system.

According to a preferred embodiment of the present disclosure, the at least one operation parameter associated with the power system comprises supplied voltage provided to the electrolysis stack and current flowing through the electrolytic stack.

Generally, all terms used in the claims are to be interpreted according to their ordinary meaning in the technical field, unless explicitly defined otherwise herein. All references to “a/an/the element, component, device, plant, system, step, etc.” are to be interpreted openly as referring to at least one instance of the element, component, device, plant, system, step, etc., unless explicitly stated otherwise.

### BRIEF DESCRIPTION OF THE DRAWINGS

Other features and advantages of the present disclosure will be better understood through the following preferred embodiment described in detail with reference to the accompanying drawings, in which a same reference sign indicates a same or similar component.

FIG. 1 shows a schematic diagram of an embodiment of an electrolysis plant according to the present disclosure.

FIG. 2 shows a schematic cross-sectional view of an electrolysis stack of the electrolysis plant shown in FIG. 1.

FIG. 3 shows a schematic diagram of a power system comprising the electrolysis plant shown in FIG. 1.

FIG. 4 shows a schematic diagram of the association between an overall model for the power system shown in FIG. 3 and a model for the electrolysis plant shown in FIG. 1.

FIG. 5 shows a multiphysics model for the electrolysis plant shown in FIG. 1, comprising a diphasic flow model bidirectional coupled with an electrochemical model.

FIG. 6 shows a schematic diagram of an electrolysis cell of the electrolysis stack shown in FIG. 2.

FIG. 7 shows a schematic two-dimensional diagram of the electrolysis cell shown in FIG. 6.

FIG. 8 shows a thin region of a flow channel, which is artificially divided to model a bubble layer in the electrolysis cell shown in FIG. 6.

FIG. 9 shows a sensitivity analysis for getting an optimal value of the width of the bubble layer for defining the thin region shown in FIG. 8.

FIG. 10 shows a microelement of the bubble layer shown in FIG. 8, which is introduced to derive mass conservation of gas.

FIG. 11 shows the mass conservation of the gas in the microelement shown in FIG. 10.

FIG. 12 shows the mass conservation of the gas in the microelement shown in FIG. 10 by introducing a new variable.

FIG. 13 shows a steady parallel flow between two parallel walls of the flow channel shown in FIG. 8.

FIG. 14 shows a schematic diagram of the electrolysis cell shown in FIG. 6 with the multiphysics model shown in FIG. 5.

FIG. 15 shows a comparison of the model shown in FIG. 5 with a CFD model in terms of current-voltage characteristics.

FIG. 16 shows a comparison of the model shown in FIG. 5 with a CFD model in terms of anodic void fraction.

FIG. 17 shows a comparison of the model shown in FIG. 5 with a CFD model in terms of cathodic void fraction.

It should be noted that the drawings not only are used for the explanation and description of the present disclosure, but also are helpful for the definition of the present disclosure when necessary.

### DETAILED DESCRIPTION

The implementation and usage of the embodiment are discussed in detail below. However, it should be understood that the specific embodiment discussed are merely intended to illustrate specific ways of implementing and using the present disclosure, and are not intended to limit the protection scope of the present disclosure.

### Electrolysis Plant

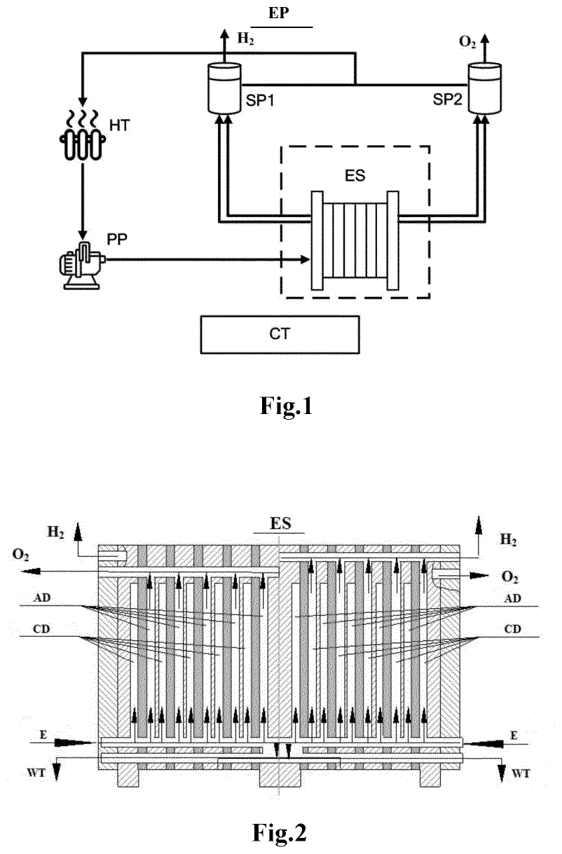

As shown in FIG. 1, the electrolysis plant EP according to the present disclosure mainly comprises: an electrolysis stack ES assembled from a plurality of electrolysis cells as shown in FIG. 2; at least one electrolysis auxiliary component comprising a heater HT, a pump PP, a first separator SP1 and a second separator SP2, wherein the heater HT is arranged upstream of the electrolysis stack ES and serves to control temperature of water (electrolyte) circulated in the electrolysis plant EP according to a control signal (generally, a supplied voltage), and the pump PP is arranged upstream of the electrolysis stack ES and serves to control flow rate of water according to a control signal (generally, a supplied voltage); the first and second separators SP1 and SP2 are arranged downstream of the electrolysis stack ES and respectively serve to separate produced hydrogen and oxygen from water; and a power supply module (not shown) configured to supply power (voltage) to the heater HT, the pump PP, the electrolysis stack ES and the first and second separators SP1 and SP2. It can be understood that the heater HT may be replaced by a heat exchanger, or may not be needed if the inlet water temperature is controlled by an external equipment.

The arrow lines shown in FIG. 1 show flow directions of fluid. More specifically, water is heated by the heater HT and then actuated by the pump PP before flowing into the electrolysis stack ES. After an electrolysis process in the electrolysis stack ES, a diphasic flow comprising water and produced gas (produced oxygen and produced hydrogen) flows from the electrolysis stack ES into the first and second separators SP1 and SP2 to separate the produced gas from water. Then, water is recirculated to the heater HT to start a new flow circle.

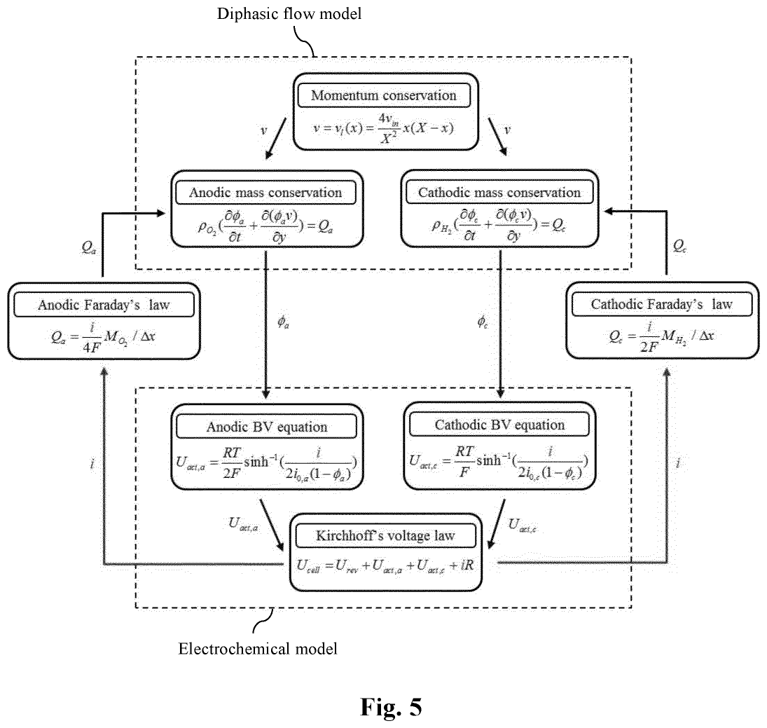

A control module CT is configured to operate the electrolysis plant EP based on a multiphysics model as shown in FIG. 5, which comprises a one-dimensional liquid-gas diphasic flow model and an electrochemical model coupled with the diphasic flow model and will be described in detail hereafter. The control module CT may be a part of the electrolysis plant EP, or may be a part of a remote server and is communicatively connected to the electrolysis stack EP and the above-mentioned auxiliary components. A processor unit of the control module CT is configured to access the multiphysics model and execute control to the electrolysis plant EP.

As shown in FIG. 2, the electrolysis stack ES is assembled from a plurality of electrolysis cells. More specifically, the electrolyte (water) E flows from both sides of the electrolysis stack ES into a common input flow channel and then into an electrolysis flow channel of each of the electrolysis cells. After the electrolysis process, the diphasic flow comprising the electrolyte E and the produced gas (the produced oxygen at anodes and the produced hydrogen at cathodes) flows out of a common output flow channel, and waste WT is discharged from a lower portion of the electrolysis stack ES.

### Power System

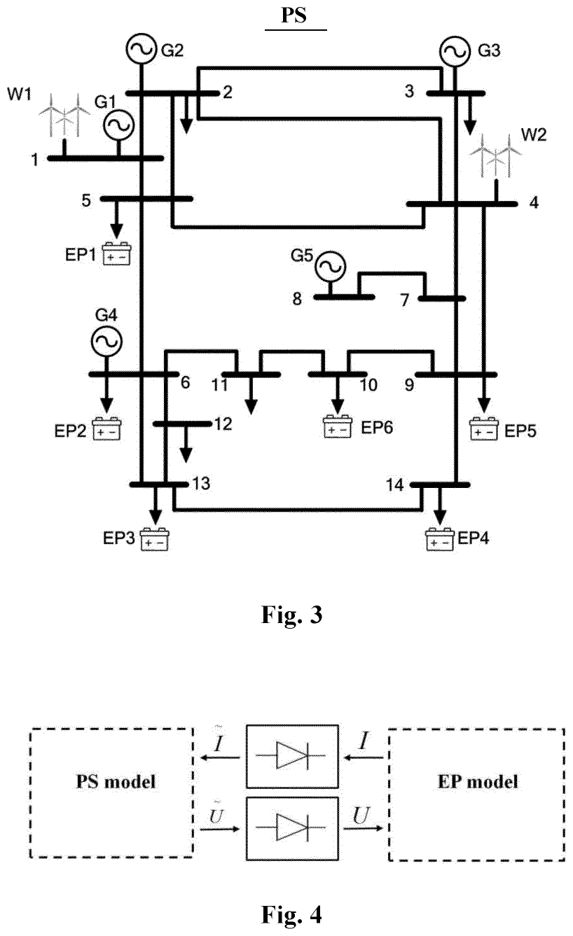

The power system shown in FIG. 3 is an exemplary system to illustrate power supply arrangement to a distributed electrolysis plant. Here, the power system PS comprises a plurality of electric devices comprising two wind turbines W1-W2 and five generators G1-G5, and six above-mentioned electrolysis plants EP1-EP6 (heavy lines indicated by reference signs 1-14 represent nodes of the power system), each of which is electrically connected to the electric devices via a rectifier and serves to store energy from the electric devices (i.e. power-to-hydrogen technology).

As shown in FIG. 4, the multiphysics model (EP model as shown in FIG. 5) comprising a one-dimensional diphasic model, to which each of the electrolysis plants EP1-EP6 is adapted, is capable of running together with an overall model for the power system (PS model) based on constant voltage control and current feedback. That is to say, the multiphysics model is suitable for an integrated simulation with the overall model for the power system PS, thereby allowing an easy and fast dispatch to the electrolysis plants EP1-EP6.

### Multiphysics Model

In the multiphysics model shown in FIG. 5, the diphasic flow model is bidirectionally coupled with the electrochemical model based on the variables Φₐ and Φ_{c} respectively representing the anodic and cathodic void fractions near catalysts, and i representing the current density. These variables are the functions of the height position in a flow channel, showing the gas and electric field distributions along the flow channel.

It is obvious that the proposed diphasic flow model is described by one-dimensional linear partial differential equations. Besides, no coupling terms exist in the model by applying the homogenous flow assumption, which will be explicitly described hereafter. Consequently, the multiphysics model is capable of being applied to the simulation to a stack or plant level electrolyzer by Matlab/Simulink.

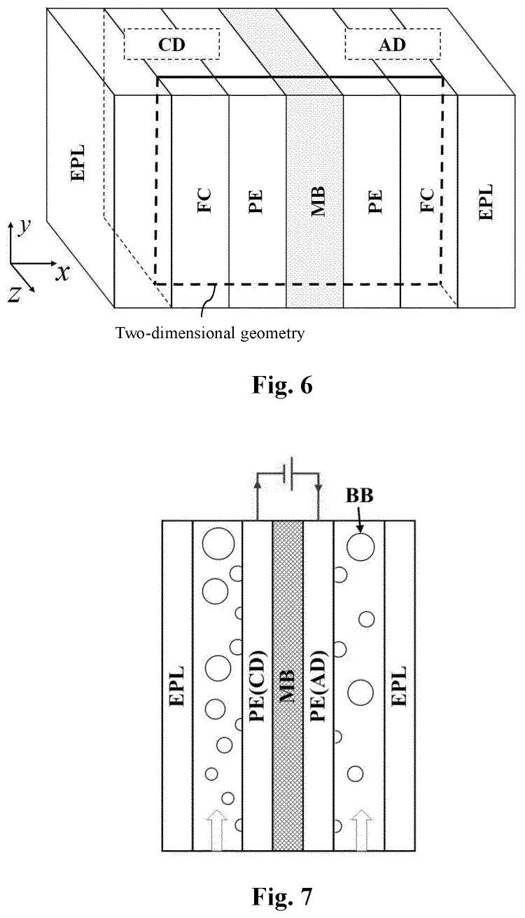

The derivation and validation processes of the multiphysics model is described in detail below with reference to FIGS. 6 to 17.

An industrial water electrolysis cell is shown in FIG. 6. It consists of a membrane MB in the middle to isolate the cathode CD and the anode AD, sandwiched by two porous electrodes PE (catalysts) and two flow channels FC sculptured on end plates EPL. In most of present structural models of such electrolysis cell, field distribution in thickness direction is ignored. Similarly, in this structural model, a two-dimensional geometry of the electrolysis cell is sketched as enclosed in a rectangle shown in FIG. 6, by ignoring the difference of the field distributions in the z-direction.

As shown in FIG. 7, when the electrolysis cell is in operation, current flows into the porous electrode PE of the anode AD and out of the porous electrode PE of the cathode CD. Hydrogen and oxygen bubbles BB are then produced at the cathodic and anodic electrodes PE respectively and carried away by circulating water in the flow channels. Based on the physical process in the electrolysis cell, the electric field is established across the electrodes PE and the membrane MB, while the diphasic flow is modeled in the flow channels.

For the multiphysics model of the electrolysis cell, the bubble distribution near the electrodes PE is a key section in the model. The bubble coverage on the electrodes PE reduces effective area of the catalysts, resulting in current decline. On the other hand, the current determines production rate of the bubbles BB. Therefore, the bubble effect is a key process in the electrolysis cell which a compelling multiphysics model should comprise.

### The Diphasic Flow Model

In a traditional diphasic flow model, the bubble distribution in a whole channel is calculated. However, from the introduction above, it can be concluded that only the bubble distribution near the electrodes should be acquired. Besides, since the bubbles are produced at the electrodes, the majority of the bubbles are gathered near the electrodes. In fact, the proportion of the bubbles drops drastically distant from the electrodes due to diffusion resistance and higher flow rate of the liquid.

Therefore, a thin region of the flow channel, the width of which is Δx, can be artificially divided to model the bubble effect in the electrolysis cell, as shown in FIG. 8. The bubble flow can be modeled in the thin bubble layer by assuming that no bubbles escape from the bubble layer.

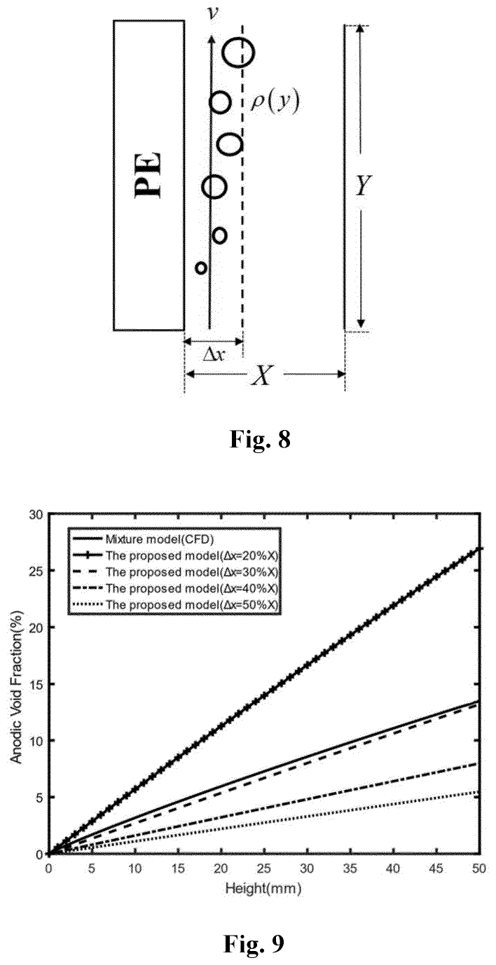

Obviously, the width of the bubble layer has a significant impact on the modeling result. A sensitivity analysis of the bubble layer width may be carried out to get the optimal value of the width, as shown in FIG. 9. From the simulation results, 30% of the flow channel width (30% X) is a better value, which is mostly in correspondence with simulation results from CFD methods. If the layer is too thin (20% X), the bubbles are restricted to be within the layer, resulting in more exaggerated bubble coverage rate; however, some of the bubbles are in fact out of the bubble layer. If the layer is too thick, the bubble coverage effect will be attenuated, since a larger area where, as a matter of fact, nearly no bubbles exist, is divided to the bubble layer.

Several assumptions are also made along with the division of the bubble layer:
The bubble layer is thin enough to ignore the velocity (flow rate) difference of the bubble flow in the x-direction.
The bubbles are generated in the thin bubble layer and are, therefore, modeled as a volumetric mass source, which means the bubble density in the x-direction is even.
No turbulence exists in the flow channel.

In this model, bubble behavior is modeled by mass conservation and momentum conservation, which will be described as follows.

### Mass Conservation

In this model, the variables Φₐ and Φ_{c} respectively represents anodic and cathodic void fractions near catalysts, and are functions of the current density i, whose calculation will be described in the next section.

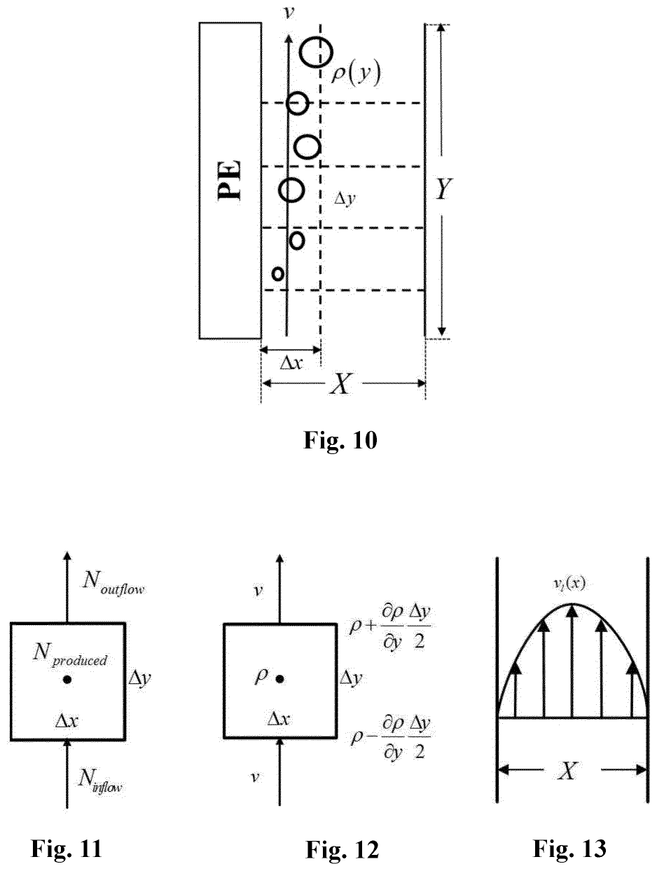

Similar to the traditional CFD methods, the microelement of the bubble layer in the flow channel is introduced to derive the mass conservation of the gas, which is a tiny area of Δx×Δy, as shown in FIG. 10.

For each fluid element at a boundary layer, the equation of mass conservation of the gas content is established according to FIG. 11:

$${N}_{increment} = {N}_{inflow} - {N}_{outflow} + {N}_{produced} \qquad ( 1 )$$

which states the increment of the mass N_{increment} equals to the difference of the inflow mass N_{inflow} and the outflow mass N_{outflow} plus the produced mass N_{produced} in the element.

To evaluate the gas content, a new variable p is defined, representing the mass of gas (kg/m³) in the bubble-layer microelement. Obviously, this variable is dependent on the height position y in the flow channel. As shown in FIG. 12, If the center of the microelement is sited y, then the bubble masses at the inlet and at the outlet can be respectively derived as:

$$ρ - \frac{d ρ}{dy} \frac{Δ y}{2} and ρ + \frac{d ρ}{dy} \frac{Δ y}{2} .$$

Therefore, the inflow mass and the outflow mass can be respectively given as:

$$\begin{matrix}{N}_{inflow} = ( ρ - \frac{\partial ρ}{\partial y} \frac{Δ y}{2} ) v Δ x & ( 2 ) \\ {N}_{outflow} = ( ρ + \frac{\partial ρ}{\partial y} \frac{Δ y}{2} ) v Δ x & ( 3 )\end{matrix}$$

wherein v represents the flow rate of the gas.

Furthermore, the mass increment and the produced mass are calculated by:

$$\begin{matrix}{N}_{increment} = \frac{\partial ρ}{\partial t} Δ x Δ y & ( 4 ) \\ {N}_{produced} = Q Δ x Δ y & ( 5 )\end{matrix}$$

wherein Q represents the gas production rate (kg/(m³·s)) induced by an electrochemical reaction, and t represents the running time of the electrolysis cell.

As a result, the equation (1) is modified as:

$$\frac{\partial ρ}{\partial t} Δ x Δ y = ( ρ - \frac{\partial ρ}{\partial y} Δ y2 ) v Δ x - ( ρ + \frac{\partial ρ}{\partial y} \frac{≢ 6 y}{2} ) v Δ x + Q Δx Δ y \qquad ( 6 )$$

wherein there are four terms in the equation, describing respectively the mass increment, the inflow mass, the outflow mass, and the produced mass.

By simplifying the equation of mass conservation (6), the continuity equation of the bubble flow in the boundary layer is derived:

$$\frac{\partial ρ}{\partial t} + \frac{\partial ( ρ v )}{\partial y} = Q \qquad ( 7 )$$

The gas production rate Q depends on the local current density. The higher the current density, the faster the gas production rate. The continuity equation (7) is supposed to be established for both the anode and the cathode:

$$\begin{matrix}\frac{\partial {ρ}_{a}}{\partial t} + \frac{\partial ( {ρ}_{a} v )}{\partial y} = {Q}_{a} & ( 8 ) \\ \frac{\partial {ρ}_{c}}{\partial t} + \frac{\partial ( {ρ}_{c} v )}{\partial y} = {Q}_{c} & ( 9 )\end{matrix}$$

Φₐ and Φ_{c} respectively represent anodic and cathodic void fractions, ranging from 0˜1. The relationship between the mass density of the bubbles and the void fraction can be given as:

$$\begin{matrix}{ρ}_{a} = {ϕ}_{a} {ρ}_{{O}_{2}} & ( 10 ) \\ {ρ}_{c} = {ϕ}_{c} {ρ}_{{H}_{2}} & ( 11 )\end{matrix}$$

wherein ρ_{O2} and ρ_{H2} are constants, representing respectively the densities of oxygen and hydrogen. When there is no bubble in the microelement (Φ=0), the bubble mass in the element is zero. Similarly, the bubble mass in the element equals to the density of gas when the element is filled with bubbles (Φ=1).

By substituting the equations (10) and (11) into (8) and (9), the gas production rates Qₐ (at the anode) and Q_{c} (at the cathode) satisfy the following equations:

$$\begin{matrix}{ρ}_{{O}_{2}} ( \frac{\partial {ϕ}_{a}}{\partial t} + \frac{\partial ( {ϕ}_{a} v )}{\partial y} ) = {Q}_{a} & ( 12 ) \\ {ρ}_{{H}_{2}} ( \frac{\partial {ϕ}_{c}}{\partial t} + \frac{\partial ( {ϕ}_{c} v )}{\partial y} ) = {Q}_{c} & ( 13 )\end{matrix}$$

Further, the gas production rates can be quantified by Faraday's Law:

$$\begin{matrix}{Q}_{a} = \frac{i}{4 F} {M}_{{O}_{2}} / Δ x & ( 14 ) \\ {Q}_{c} = \frac{i}{2 F} {M}_{{H}_{2}} / Δ x & ( 15 )\end{matrix}$$

wherein i represents the current density to be acquired in the electrochemical model, F represents the Faraday's constant, and M_{O2} and M_{H2} represent respectively the molar masses of oxygen and hydrogen.

### Momentum Conservation

In this section, the calculation of the flow rate v of the gas is described based on momentum conservation.

In a traditional diphasic flow model, the Navier-Stokes equation, which is nonlinear and high-dimensional, is adapted to describe the momentum conservation of the fluid:

$$ρ \frac{\partial \vec{v}}{\partial t} + ρ \vec{v} ∇ \vec{v} = f - ∇ p + μ {∇}^{2} \vec{v} \qquad ( 16 )$$

which describes the momentum increment of the fluid depends on the external force f, the pressure difference ∇p, and the viscosity force μ∇²\vec{ν}.

Obviously, the equation (16) is highly nonlinear due to the expressions of the momentum increment and the viscosity. Therefore, in this model, two strategies are proposed to avoid the nonlinearity.

### The Homogeneous Flow Assumption:

In this model, however, the homogeneous flow assumption of the diphasic flow is adapted to avoid the nonlinearity, stating that the flow rates (velocities) of the gas and the liquid are equivalent:

$$v = {v}_{l} \qquad ( 17 )$$

wherein vₗ represents the flow rate of the liquid.

Therefore, the momentum conservation of the gas can be replaced by that of the liquid.

### The Analytical Solution of the Steady Parallel Flow:

In the electrolysis unit, the liquid flow can be regarded as a steady parallel flow between two parallel walls, as shown in FIG. 13. As a result, several simplifications can be made for the Navier-Stokes equation (16) and the analytical solution is acquired.

Firstly, the first term

$$ρ \frac{\partial v}{\partial t}$$

can be eliminated since the transient process of the liquid is ignored.

Secondly, the convection term ρ\vec{ν}∇\vec{ν} can be simplified to a one-dimensional form

$$ρ {v}_{l} \frac{\partial {v}_{l}}{\partial y} .$$

Further, since the flow rate is constant in y-direction, it can be inferred that:

$$\frac{\partial {v}_{l}}{\partial y} = 0 \qquad ( 18 )$$

As a result, the second term can also be eliminated.

Thirdly, no external force is applied to the liquid so that:

$$f = 0 \qquad ( 19 )$$

Fourthly, the pressure term can be simplified through dimension reduction as

$$\frac{dp}{dy} .$$

Finally, the viscosity term can also be simplified as

$$\frac{{d}^{2} {v}_{l}}{{dx}^{2}} .$$

Therefore, the Navier-Stokes equation (16) of the liquid can be simplified to:

$$\frac{{d}^{2} {v}_{l}}{{dx}^{2}} = \frac{1}{μ} \frac{dp}{dy} \qquad ( 20 )$$

wherein μ represents the viscosity of the liquid, p represents the pressure of liquid.

Furthermore, the definite conditions of the Navier-Stokes equation are given as:

$$\{ \begin{matrix}{v}_{l} ( x = 0 ) = 0 \\ {v}_{l} ( x = \frac{1}{2} X ) = {v}_{in} \\ {v}_{l} ( x = X ) = 0\end{matrix} \qquad ( 21 )$$

wherein vᵢₙ represents the flow rate of the liquid at the central position along the width direction of the flow channel, x represents the width position in the flow channel, and X represents the total width of the flow channel.

By substituting the conditions (21) into the equation (20), the flow rate of the liquid satisfies the following equation:

$${v}_{l} ( x ) = \frac{4 {v}_{in}}{{X}^{2}} ( - {x}^{2} + Xx ) \qquad ( 22 )$$

Therefore, based on the mass conservation (7) and the momentum conservation (17) (22), the mass density of the gas can be solved according to:

$$\frac{\partial ρ}{\partial t} + \frac{\partial p}{\partial y} \frac{4 {v}_{in}}{{X}^{2}} ( - {x}^{2} + Xx ) = Q \qquad ( 23 )$$

From the equation (23), it can be seen that the proposed diphasic flow model is one-dimensional, embodying the bubble distribution in the y-direction.

The boundary and the initial conditions of the differential equation (23) are as follows.

At the inlet, it is supposed to have no bubbles, constrained by:

$$ρ ( y = 0 ) = 0 \qquad ( 24 )$$

Besides, no bubble is produced before start of the electrolysis cell:

$$ρ ( t = 0 ) = 0 \qquad ( 25 )$$

### The Electrochemical Model

The calculation of the current density i is described in this section.

The electrochemical model is established to acquire the current density distribution i(y) along the channel. When the electrolysis cell is in operation, the electric field is established across the membrane and the current flows from the anodic electrode to the cathodic electrode. At the same time, the electrodes will be activated, which pulls down the potential of the cathode and elevates the potential of the anode. The Kirchholf's voltage law is established as:

$${U}_{cell} = {U}_{rev} + {U}_{acta ,} + {U}_{act , c} + {iR}_{ohm} \qquad ( 26 )$$

wherein U_{cell} represents the supplied voltage of the electrolysis cell, Uᵣₑᵥ represents the reversible voltage and equals 1.23V under a near-ambient temperature, U_{act,a} and U_{act,c} respectively represent the activation overvoltages of anode and cathode, and iRₒₕₘ represents the ohmic overvoltage due to resistance effect.

The Butler-Volmer equations are adapted to describe electrode activation, that is, the relationship between the current density and the electric potential:

$$\begin{matrix}{U}_{act , a} = \frac{RT}{2 F} {sinh}^{- 1} ( \frac{i}{2 {i}_{0 , a}} ) & ( 27 ) \\ {U}_{act , c} = \frac{RT}{F} {sinh}^{- 1} ( \frac{i}{2 {i}_{0 , c}} ) & ( 28 )\end{matrix}$$

wherein R represents the gas constant, T represents the temperature of water, F represents the Faraday's constant, i represents the current density, i_{0,a} and i_{0,c} respectively represent the exchange current densities of the anode and the cathode.

It can be inferred from the Butler-Volmer equations that the higher the current density, the higher the activation overvoltage.

However, in this model, the bubble effect on the electrochemical reaction is considered. As described above, the bubble coverage on the electrodes reduces the effective area of the electrochemical reaction. Therefore, the Butler-Volmer equations (23) (24) are modified considering the bubble effect:

$$\begin{matrix}{U}_{act , a} = \frac{RT}{2 F} {sinh}^{- 1} ( \frac{i}{2 {i}_{0 , a} ( 1 - {ϕ}_{a} )} ) & ( 29 ) \\ {U}_{act , c} = \frac{RT}{F} {sinh}^{- 1} ( \frac{i}{2 {i}_{0 , c} ( 1 - {ϕ}_{c} )} ) & ( 30 )\end{matrix}$$

By substituting U_{act,a} and U_{act,c} in the equation (26) by (29) and (30), an implicit function of i, Φₐ and Φ_{c} is obtained:

$${U}_{cell} = {U}_{rev} + \frac{RT}{2 F} {sinh}^{- 1} ( \frac{i}{2 {i}_{0 , a} ( 1 - {ϕ}_{a} )} ) + \frac{RT}{F} {sinh}^{- 1} ( \frac{i}{2 {i}_{0 , c} ( 1 - {ϕ}_{c} )} ) + {iR}_{ohm} \qquad ( 31 )$$

By combining the equations (12)-(15), (17), (22) and (31), the variables i, Φₐ and Φ_{c} can be resolved.

### The Overview of the Multiphysics Model

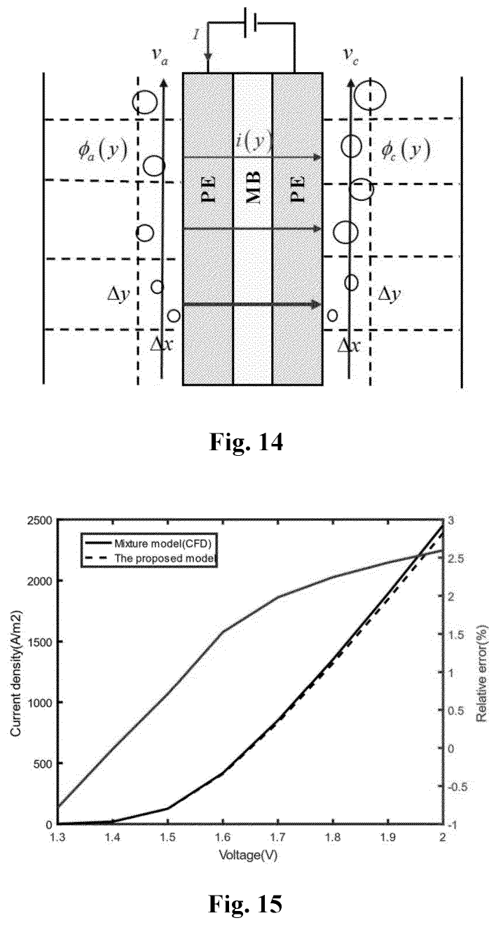

In the complete multiphysics model, the diphasic flow model and the electrochemical model should be established at both the anode and the cathode, associated by the current density across the electrolysis cell, as shown in FIG. 14.

Therefore, the complete model of the electrolysis cell is shown in FIG. 5. Firstly, the diphasic flow model for both the anode and the cathode is established to acquire the void fraction distributions Φₐ(y) and Φ_{c}(y) along the channels. The Faraday's law is applied to quantify the gas production rates, wherein the monodirectional coupling from the electrochemical model to the diphasic flow model is established. Further, the modified Butler-Volmer equations of the anode and the cathode are established by considering the bubble effect on the electrochemical reaction. As a result, the diphasic flow model and the electrochemical model are bidirectionally coupled. Finally, the Butler-Volmer equations of the anode and the cathode are associated through the Kirchhoff's voltage law of the electrolysis cell.

### Validation of the Multiphysics Model

The complete model of the electrolysis cell may be established and simulated in Simulink/Matlab. The model shall be validated by comparing the simulation results with those of the mixture model (CFD model) in Comsol Multiphysics.

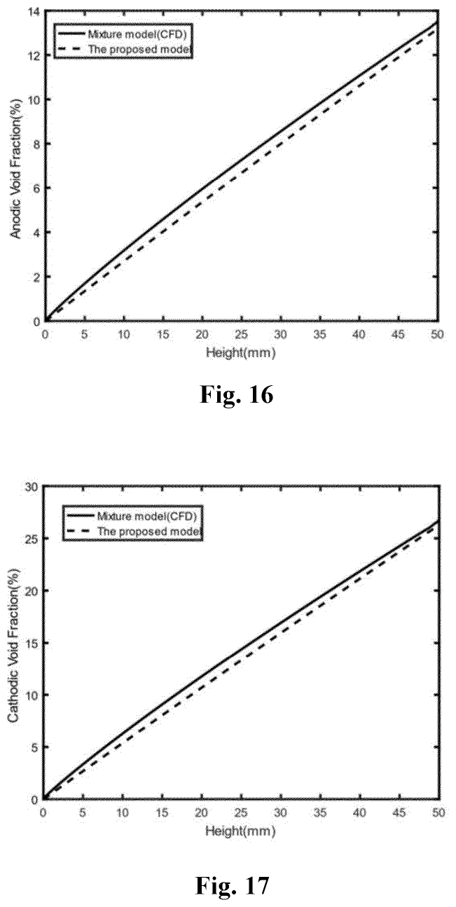

Firstly, bubble distributions of the proposed model and the CFD model are compared as shown in FIGS. 16-17. With a proper selection of the width of the bubble layer (30% X), the void fractions near the electrodes are quasi-identical at both the anode and the cathode with the two models.

Furthermore, the current-voltage (I-V) characteristics of the electrolysis cell with the two models are shown in FIG. 15. From the simulation results, the relative error of the I-V characteristics between the two models is less than 3%. Therefore, the validity of the proposed model can be proved.

To conclude, the proposed flow model aims at acquiring gas distribution near an electrode catalyst at different heights, and is liquid-gas decoupled, one-dimensional, and linear. Further, the proposed diphasic flow model is bidirectionally coupled with the electrochemical model to get the accurate current density of the electrolysis cell, wherein the bubble effect on the electrolysis process is considered.

More specifically, the proposed diphasic flow model:
is established by linear partial differential equations, which can be solved by Simulink/Matlab;
decouples the variables of liquid and gas, and thereby improving the convergence;
only solves the amount of the bubbles near the electrodes, thereby reducing the computing scale.

### Applications of the Multiphysics Model

As described above, the electrolysis cells are usually compactly assembled in stacks, yet there are still limited diphasic flow researches in stack-level due to extremely high computing scale with traditional CFD methods. The proposed model solves the problem for fast calculation and good convergence. Therefore, the bubble distribution in the electrolysis stack can be optimized with the proposed model to improve overall efficiency.

With regard to the electrolysis plant EP shown in FIG. 1 comprising the electrolysis stack ES, the proposed model according to the present disclosure allows an easy and fast control to the electrolysis plant EP. More specifically, a method for operating the electrolysis plant EP may comprise following steps executed by the control module CT:
a) adapting the multiphysics model as shown in FIG. 5 to a plurality of operation parameters of the electrolysis plant EP, which comprises at least one preset parameter and at least one parameter to be calculated;
b) calculating a value of the at least one parameter to be calculated according to a preset value of the at least one preset parameter by means of the multiphysics model; and
c) executing control to the electrolysis plant EP according to the calculated value of the at least one parameter to be calculated.

For example, when operating the electrolysis plant EP by means of the proposed model, the at least one preset parameter may comprise the current density i and the anodic and cathodic void fractions Φₐ and Φ_{c}, and the at least one parameter to be calculated may comprise the flow rate vₗ of water, the temperature T of the water and the supplied voltage provided to the electrolysis stack ES. Further, some of the operation parameters, such as the supplied voltage provided to the electrolysis stack ES and the current flowing through the electrolytic stack ES, may be measured when monitoring the electrolysis plant EP during operation.

According an embodiment, the method comprises calculating a value of the flow rate vₗ of water according to preset values (expected values) of the current density i and the anodic and cathodic void fractions Φₐ and Φ_{c} by means of the above-mentioned diphasic flow model, and then determining the control signal, such as the supplied voltage, provided to the pump PP according to the calculated value of the flow rate vₗ, and executing control to the pump PP according to the control signal provided to the pump PP, for example, by providing the supplied voltage setpoint to the power supply module.

According another embodiment, the method comprises calculating values of the temperature T of the water and the supplied voltage provided to the electrolysis stack ES according to preset values (expected values) of the current density i and the anodic and cathodic void fractions Φₐ and Φ_{c} by means of the above-mentioned electrochemical model, and then determining the control signal, such as the supplied voltage, provided to the heater HT according to the calculated value of the temperature T, and executing control to the heater HT and the electrolysis stack ES respectively according to the control signal provided to the heater HT and the supplied voltage provided to the electrolysis stack ES, for example, by providing the supplied voltage setpoints to the power supply module.

The proposed model may also be applied to monitor the electrolysis plant EP (for example, digital twin). More specifically, the multiphysics model established in a digital space (for example, in the remote server) may be initialized to be synchronized with the real electrolysis plant EP. Therefore, conditions of the electrolysis plant EP can be monitored according to deviation of states of the two spaces, such as aging failure detection and abnormal operation condition detection.

According to an embodiment, after the above-mentioned step c), the method may further comprise measuring a value of at least one operation parameters of the electrolysis plant EP, for example, the supplied voltage provided to the electrolysis stack ES and current flowing through the electrolytic stack ES, and observing if the measured value varies abruptly over a time period, so as to identify if a failure, such as membrane rupture, catalyst shedding, etc., happens in the electrolysis plant EP.

Further, a traditional diphasic flow model is dependent on CFD solvers (e.g. Comsol Multiphysics, Ansys Fluent), which are not suitable for an integrated simulation with a power system. The proposed model solves the problem since it can be established and resolved by Matlab/Simulink.

With regard to the power system PS shown in FIG. 3 comprising the electrolysis plant EP shown in FIG. 1, the proposed model according to the present disclosure allows an easy and fast dispatch to the electrolysis plants EP1-EP6 based on an integrated simulation with an overall model for the power system PS. More specifically, a method for dispatching the electrolysis plants EP1-EP6 in the power system PS may comprises following steps:
adapting the multiphysics model as shown in FIG. 5 to a plurality of operation parameters of the electrolysis plants EP1-EP6;
running the multiphysics model together with the model of the power system PS based on at least one of the plurality of operation parameters associated with the power system PS, for example, the supplied voltage provided to the electrolysis stack ES and the current flowing through the electrolytic stack ES;
determining state of operation, for example, start and stop, of the electrolysis plants EP1-EP6 (i.e. dispatching the electrolysis plants EP1-EP6 before operation of the power system PS) based on a running result to optimize performance of the power system PS.

For example, at the location of a node in the power system PS with a high current, an electrolysis plant connected to the node can be activated to store energy (i.e. PtH technology); while at the location of a node in the power system PS with a low current, an electrolysis plant connected to the node can be stopped. In fact, the electrolysis plants EP1-EP6 can be jointly dispatched according to the powers of the electric devices and a reasonable energy storage strategy, thereby optimizing the performance of the power system PS.

The technical content and features of the present disclosure have been disclosed above. However, it is conceivable that, under the creative ideas of the present disclosure, those skilled in the art can make various changes and improvements to the concepts disclosed above, but these changes and improvements all belong to the protection scope of the present disclosure. The description of the above embodiment is exemplary rather than restrictive, and the protection scope of the present disclosure is defined by the appended claims.

1. A method for operating an electrolysis plant (EP), the electrolysis plant (EP) comprising:
an electrolysis stack (ES) assembled from a plurality of electrolysis cells; and
at least one electrolysis auxiliary component arranged upstream or downstream of the electrolysis stack (ES);
wherein the method comprises following steps executed by a control module (CT):
a) adapting a multiphysics model to a plurality of operation parameters of the electrolysis plant (EP), the multiphysics model comprising a one-dimensional liquid-gas diphasic flow model and an electrochemical model coupled with the diphasic flow model, and the plurality of operation parameters comprising at least one preset parameter and at least one parameter to be calculated;
b) calculating a value of the at least one parameter to be calculated according to a preset value of the at least one preset parameter by means of the multiphysics model; and
c) executing control to the electrolysis plant (EP) according to the calculated value of the at least one parameter to be calculated.

2. The method for operating an electrolysis plant (EP) according to claim 1, wherein the at least one electrolysis auxiliary component comprises at least one of a heater (HT), a heat exchanger, and a pump (PP), wherein the heater (HT) or the heat exchanger is configured to control temperature of electrolyte circulated in the electrolysis plant (EP) according to a control signal provided to the heater (HT) or the heat exchanger, and wherein the pump (PP) is configured to control flow rate of the electrolyte according to a control signal provided to the pump (PP).

3. The method for operating an electrolysis plant (EP) according to claim 2, wherein the step b) comprises calculating a value of the flow rate of the electrolyte according to preset values of current density and anodic and cathodic void fractions by means of the diphasic flow model established for a single electrolytic cell based on mass conservation, momentum conservation, assumptions of homogeneous flow and steady parallel flow and the Faraday's law, and wherein the step c) comprises determining the control signal provided to the pump (PP) according to the calculated value of the flow rate, and executing control to the pump (PP) according to the control signal provided to the pump (PP).

4. The method for operating an electrolysis plant (EP) according to claim 3, wherein the flow rate of the electrolyte is represented by the following equation based on momentum conservation and assumptions of homogeneous flow and steady parallel flow in order to simplify the calculation:
$$v = {v}_{1} ( x ) = \frac{4 {v}_{in}}{{X}^{2}} x ( X - x )$$
wherein ν represents a flow rate of gas, ν₁ represents the flow rate of the electrolyte, νᵢₙ represents the flow rate of the electrolyte at a central position along a width direction of a flow channel of the electrolysis cell, x represents a width position in the flow channel, and X represents a total width of the flow channel.

5. The method for operating an electrolysis plant (EP) according to claim 2, wherein the step b) comprises calculating values of the temperature of the electrolyte and supplied voltage provided to the electrolysis stack (ES) according to preset values of current density and anodic and cathodic void fractions by means of the electrochemical model established for a single electrolytic cell based on the Kirchhoff's voltage law and the Bulter-Volmer equation, and wherein the step c) comprises determining the control signal provided to the heater (HT) or the heat exchanger according to the calculated value of the temperature, and executing control to the heater (HT) and the electrolysis stack (ES) respectively according to the control signal provided to the heater (HT) or the heat exchanger and the supplied voltage provided to the electrolysis stack (ES).

6. The method for operating an electrolysis plant (EP) according to claim 1, wherein after the step c), the method further comprises a following step:
d) measuring a value of at least one operation parameter of the electrolysis plant (EP) and observing if the measured value varies abruptly over a time period, so as to identify if a failure happens in the electrolysis plant (EP).

7. The method for operating an electrolysis plant (EP) according to claim 6, wherein the at least one measured operation parameter comprises supplied voltage provided to the electrolysis stack (ES) and current flowing through the electrolytic stack (ES).

8. A control module for operating an electrolysis plant (EP), the electrolysis plant (EP) comprising:
an electrolysis stack (ES) assembled from a plurality of electrolysis cells; and
at least one electrolysis auxiliary component arranged upstream or downstream of the electrolysis stack (ES);
wherein the control module (CT) is configured to:
adapt a multiphysics model to a plurality of operation parameters of the electrolysis plant (EP), the multiphysics model comprising a one-dimensional liquid-gas diphasic flow model and an electrochemical model coupled with the diphasic flow model, and the plurality of operation parameters comprising at least one preset parameter and at least one parameter to be calculated;
calculate a value of the at least one parameter to be calculated according to a preset value of the at least one preset parameter by means of the multiphysics model; and
execute control the electrolysis plant (EP) according to the calculated value of the at least one parameter to be calculated.

9. An electrolysis plant comprising the control module (CT) according to claim 8.

10. The electrolysis plant according to claim 9, wherein the at least one electrolysis auxiliary component comprises at least one of a heater (HT), a heat exchanger and a pump (PP), wherein the heater (HT) or the heat exchanger is configured to control temperature of electrolyte circulated in the electrolysis plant (EP) according to a control signal provided to the heater (HT) or the heat exchanger, and wherein the pump (PP) is configured to control flow rate of the electrolyte according to a control signal provided to the pump (PP).

11. A method for dispatching at least one electrolysis plant (EP) in a power system, the power system comprising at least one electric device electrically connected to the at least one electrolysis plant (EP) comprising an electrolysis stack (ES) assembled from a plurality of electrolysis cells, wherein the method comprises following steps:
adapting a multiphysics model to a plurality of operation parameters of the at least one electrolysis plant (EP), the multiphysics model comprising a one-dimensional liquid-gas diphasic flow model and an electrochemical model coupled with the diphasic flow model;
running the multiphysics model together with a model of the power system based on at least one of the plurality of operation parameters associated with the power system; and
determining state of operation of the at least one electrolysis plant (EP) based on a running result to optimize performance of the power system.

12. The method for dispatching at least one electrolysis plant (EP) in a power system according to claim 11, wherein the at least one operation parameter associated with the power system comprises supplied voltage provided to the electrolysis stack (ES) and current flowing through the electrolytic stack (ES).
